(19) United States
(12) Patent Application Publication
(10) Pub. No.: US 2026/0350295 A1
(43) Pub. Date: Nov. 5, 2026

(54) LARGE-SCALE CODE CUSTOMIZATION

(71) Applicant: AMADEUS S.A.S., Biot (FR)

(72) Inventors: Jorge DE ANTONIO DEL PECHO, Madrid (ES); Hongliu CAO, Nice (FR); Anna TSOLAKOU, Madrid (ES); Minji KIM, Nice (FR)

(21) Appl. No.: 19/641,853

(22) Filed: Apr. 8, 2026

(30) Foreign Application Priority Data
Apr. 30, 2025 (DE) 20 2025 102 391.1

(51) Int. Cl. G06F 40/151; G06F 40/14

(52) U.S. Cl. CPC G06F 40/151; G06F 40/14

(57) ABSTRACT

A computerized system for modifying a structured document in an efficient and reliable manner is provided. The system is configured to: receive the structured document, wherein the structured document comprises multiple items; summarize the structured document based on grouping the items to obtain a global summary of the structured document; receive a query to modify the structured document; refine the query to specify the sought modification of the structured document more meaningfully; generate an instruction to modify the structured document based on the refined query and the global summary; and modify the structured document based on the instruction and the global summary. A corresponding computer program and computer implemented method are also provided.

### FIELD

The present disclosure relates to a technique, e.g. a computerized system, a computing device and a computer program, for modifying structured documents to mitigate computational load.

### BACKGROUND

Structured documents, used in information technology, are increasing in length and complexity. Deeply nested structures and extensive use of references contribute to the complexity of a structured document. Additionally, structured documents may become dynamic through placeholders, such as those in templating systems. Modifying the structured document solely by hand is no longer feasible. Modifying the structured document can also be computationally complex. Hence, methodologies are sought to facilitate efficient and reliable modifying of structured documents.

### SUMMARY

In view of the above, an object of the present disclosure is to mitigate/reduce computational load (which may also be referred to as computational effort, computational expenditure or use of computational resources) involved in the modification of structured documents.

In order to achieve this objective, there are provided a computerized system, a computing device and a computer program, as defined in the claims.

An aspect of the present disclosure provides a computerized system for modifying a structured document, the system being arranged to:
receiving the structured document, wherein the structured document comprises multiple items
summarizing the structured document based on grouping the items to obtain a global summary of the structured document;
receiving a query to modify the structured document;
refining the query to specify the sought modification of the structured document more meaningfully;
generating an instruction to modify the structured document based on the refined query and the global summary;
modifying the structured document based on the instruction and the global summary.

The present specification also provides a computing device and a computer program with program instructions according to the foregoing.

### BRIEF DESCRIPTION OF THE FIGURES

Aspects and examples of the present disclosure are described with reference to the following figures, in which:

FIG. 1A depicts an example of a structured document.

FIG. 1B visualizes the tree structure of the sample structured document.

FIG. 2 schematically shows an exemplary system implementing the present methodologies.

FIG. 3 visualizes grouping methodologies described herein.

FIG. 4 schematically depicts a summarization process.

FIG. 5 depicts a feedback loop.

FIG. 6 visualizes an agentic system.

FIG. 7A to 7C provides examples of input prompts for large language models.

FIG. 8 shows an internal structure of a computing machine implementing the present methodologies.

### DETAILED DESCRIPTION

The present disclosure addresses a technical problem in information technology, and more specifically in modifying structured documents. Structured documents are usually very lengthy because the documented systems are increasingly complex. Structured documents contain deeply nested structures reducing the human readability of the content. Commonly, references are used extensively to reduce duplication and ease maintenance. Placeholders, such as those in templating systems, allow dynamic content generation and increase flexibility and configurability. However, both methods increase complexity and decrease readability of structured documents.

Classic computing methods and machine learning models are powerful tools for processing large and complex structured documents. However, programming traditional algorithms to account for every placeholder, reference or special case can quickly become just as intricate as the problem itself. Machine learning models, while effective, also face challenges with large files. In particular, large language models (LLMs) have a fixed and limited context window for input and output, complicating processing large files in a single pass. A context window is the amount of text in the form of tokens the model can process at once. A token is a unit of text that LLMs process at one time. A token can represent a word, subunit or character, depending on the tokenization method used. The typical maximum input number of tokens ranges between 4,000 to 120,000 tokens, with some models being able to input up to 980,000 tokens. However, in very large contexts, there is a trade-off, with declines in recall, reasoning and focus. An optimal input window may range between 600 to 800 tokens, depending on the complexity of the context. Nevertheless, the limiting factor usually lies in the maximum number of tokens the model can generate. This output limit is typically lower than the input context window, generally ranging from 2,000 to 8,000 tokens. Large files, by comparison, often exceed 10,000 tokens. Thus, large files may not be processed in a single pass.

The technical problem addressed by the present methodologies is to modify structured documents more efficiently given the file length and complexity.

Structured documents are text-based electronic files that use a formal structure to represent information in a machine-readable format. Structured documents follow standardized syntax, such as key-value pairs, nested elements or attribute-based structures, to ensure consistency and interoperability. These documents contain various types of data, such as metadata, configurations, records or entities, collectively referred to as items.

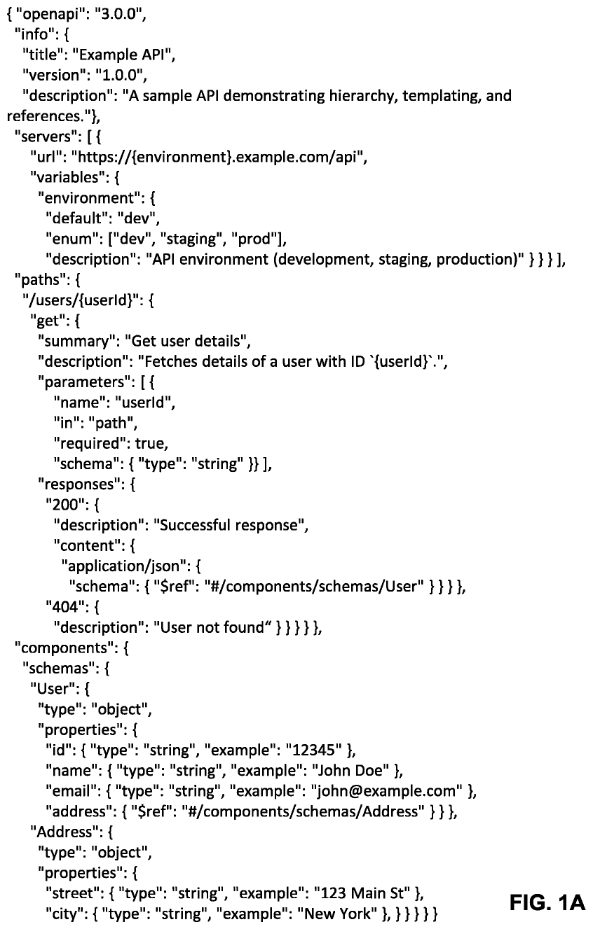

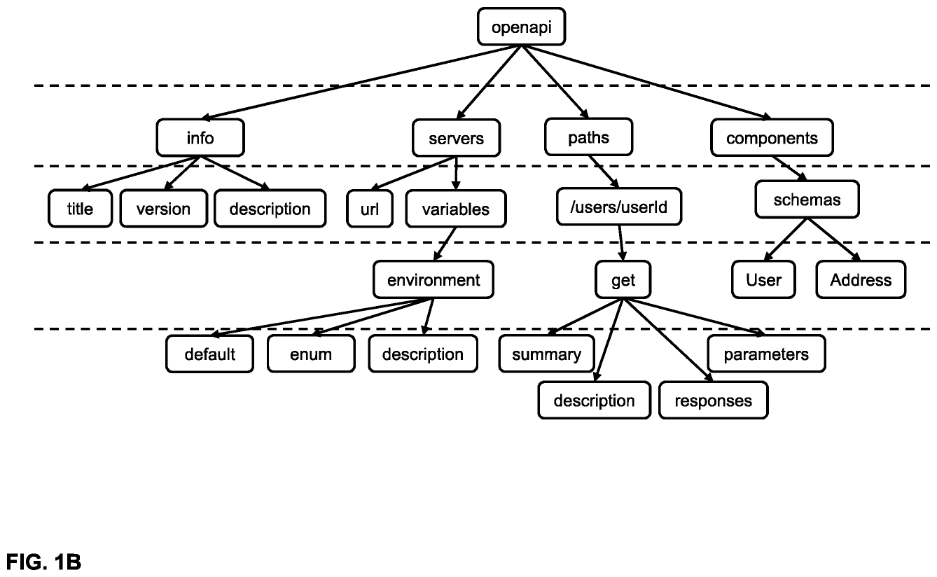

Common structured document formats include Extensible Markup Language (XML), JavaScript Object Notation (JSON), YAML Ain't Markup Language (YAML) and Hypertext Markup Language (HTML). A simple example is shown in FIG. 1A, where a JSON-formatted sample Application Programming Interface (API) follows the OpenAPI specification-often referred to as a Swagger file. It defines a base Uniform Resource Locator (URL) with three possible environments for development (dev), intermediate testing (stage) and production (prod) as well as an endpoint to fetch user details by identification (ID).

Structured documents frequently employ placeholders within their content. A placeholder, such as ‘{environment}’ in the ‘server’ section, represents a variable value that can be dynamically substituted at runtime. Similarly, ‘{userID}’ is used as a placeholder to personalize API requests. This technique, known as templating, allows structured documents to be more flexible and reusable across different contexts, reducing redundancy and enabling efficient customization.

However, templating also introduces complexity. Parsing structured documents requires correctly resolving placeholders, ensuring proper substitutions and maintaining consistency across references. Without careful management, errors in substitution can lead to incorrect or incomplete document outputs.

In addition to templating, structured documents often use references to avoid data duplication and enforce consistency. References allow different sections of a document to be linked, ensuring that commonly used structures are defined once and reused multiple times. For example, in the JSON sample in FIG. 1A a ‘$ref’ key in the ‘components/schemas/User’ section points to the ‘Address’ schema: ‘{“$ref”: “#/components/schemas/Address”}’. This approach ensures that updates to the ‘Address’ schema automatically propagate wherever the schema is referenced, improving maintainability and reducing errors.

However, working with references adds another layer of complexity. Resolving references correctly requires following a structured document's internal linking rules, handling nested references and ensuring that all dependencies are properly loaded.

Managing such dependencies and ensuring accurate resolution becomes increasingly challenging as document size grows. For example, some comprehensive API specifications can exceed 20,000 lines, making manual handling impractical and increasing the need for advanced processing techniques.

Generally, the present methodologies seek to efficiently modify a structured document according to a query. The general aim is to render working with large files that are too complex for manual handling more efficiently. The present methodologies can thus provide enhanced options for handling structured documents, ensuring faster processing, greater efficiency, improved accuracy and better clarity. Solutions are provided in the form of methods, computer-program instructions, computer programs etc. for modifying a document.

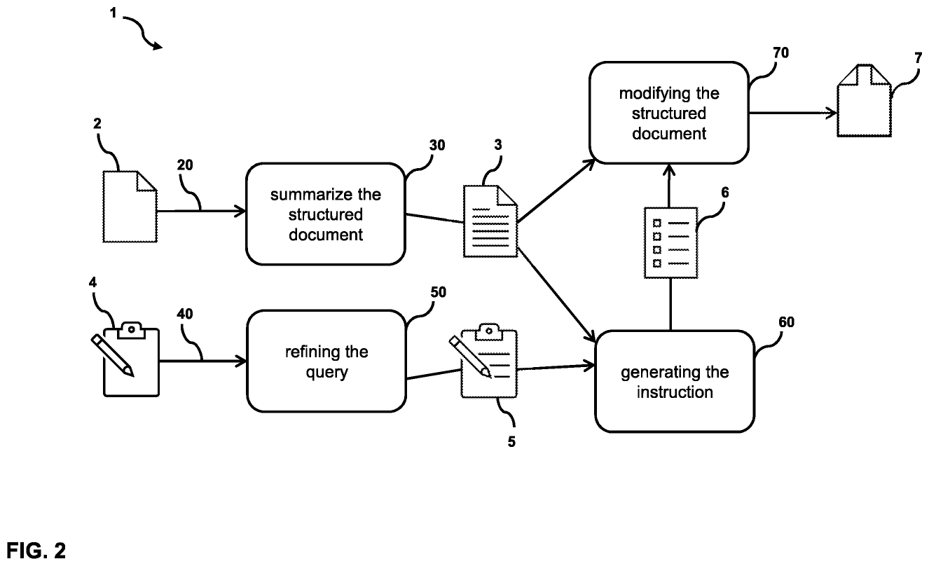

FIG. 2 visualizes the executed actions and data flow for processing a structured document. The computer implemented method 1 receives 20 the structured document 2. The comprising items are grouped and summarized 30 to obtain a global summary 3 of the structured document 2. The method 1 also receives 40 a query 4 which contains directions on how to modify the structured document 2. Subsequently, the query 4 is refined 50 so the sought modification is expressed more meaningfully, thus obtaining a refined query 5. The actions 20 and 30 can be executed sequentially before or after the actions 40 and 50, as well as parallel to each other. Then, the method 1 generates 60 an instruction 6 to modify the structured document 2 based on the previously obtained refined query 5 and global summary 3. Finally, based on the instruction 6 and the global summary 3, the modification of the structured document is executed 70 to obtain the modified document 7.

The methodologies may be executed using various technical instruments, including but not limited to classical algorithms and AI-based techniques, or hybrid methods that combine both. Classical algorithms are well-suited for deterministic, well-structured problems where strict rules and predefined patterns govern processing, such as syntax validation using finite state machines, regular expressions or parsing algorithms. These methods are efficient, interpretable and ideal when the data format is rigid and well-defined.

In contrast, AI-based techniques are beneficial for more complex, ambiguous or evolving structures where predefined rules and deterministic algorithms may fall short. These methods leverage machine learning and neural networks to recognize patterns, detect anomalies and adapt to variations in input. One example is large learning models (LLMs), which leverage vast amounts of training data and self-attention mechanisms to infer patterns, context and meaning beyond rigid rule-based approaches. LLMs are particularly useful for handling unstructured or semi-structured data, anomaly detection and adapting to variations in input that classical algorithms might struggle with. Hybrid approaches can leverage the efficiency and reliability of classical algorithms while incorporating AI for flexibility and adaptability.

The methodology may be executed through a variety of methods, each suited to the specific needs of the task at hand. The methodology may be solely executed using classical algorithms, which rely on predefined, rule-based approaches for processing data. Alternatively, the invention may be carried out entirely through AI-based techniques, leveraging machine learning models to adapt and learn from data. In some cases, the invention could depend solely on LLMs, either using a single LLM model throughout the entire process or employing different LLMs for distinct processing actions. Additionally, the invention may combine classical algorithms with AI-based techniques, selecting the most appropriate method for each processing action to optimize performance. In some embodiments, the system might incorporate an agentic structure, where autonomous agents coordinate and make decisions in real-time, enhancing efficiency and adaptability.

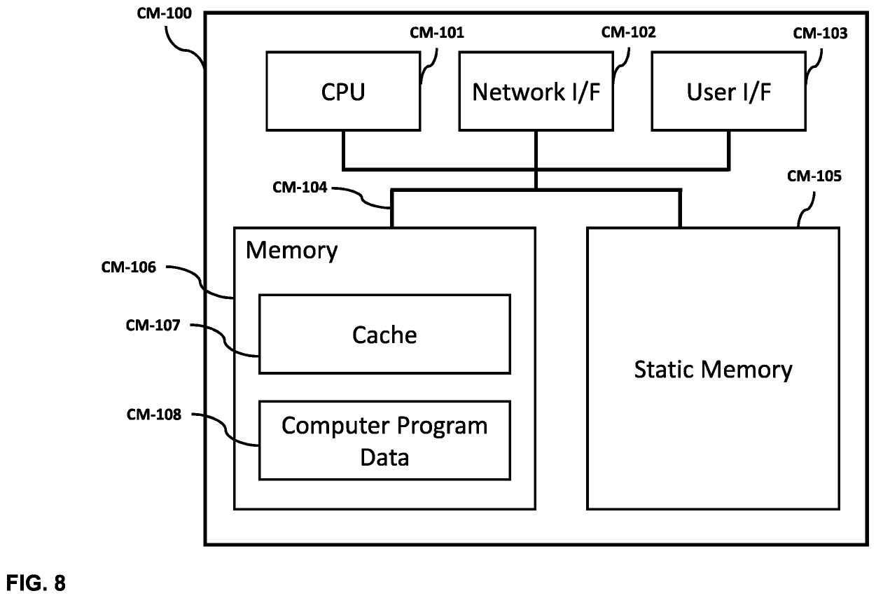

In the first two actions of the method 1, the structured document 2 is received 20 and summarized 30 into a global summary 3. The structured document 2 comprises multiple items and serves as the input of the following actions, as illustrated in FIG. 2. Once the structured document 2 has been received 20, the summarization action 30 is performed to condense the structured document 2 into a global summary 3. The structured document 2 may be received by user input or a network transmission. The structured document 2 may also be received by accessing the structured document 2 from memory (cf. FIG. 8 and description below). The summarization process 30 is performed on grouped items of the structured document 2, ensuring a manageable and efficient processing workflow. The items may be grouped based on a simple line limit, starting at the top of the structured document 2 and iteratively grouping the items until the end of the structured document 2. The items may also be grouped according to the logical structure of the structured document 2. Functional subject-matter or operational topics may also serve as the basis to group the items. The generated output, shown in FIG. 2, is the global summary 3.

In some embodiments, the summarization process may begin by extracting the hierarchy of the structured document 2 and building a tree structure with tree nodes. This process may also be referred to as structured splitting. In FIG. 1B an exemplary tree structure is built up to the fifth level from the sample structured document given in FIG. 1A. The tree structure follows the hierarchy present in the sample JSON document from FIG. 1A. To create the tree structure, the method 1 iterates over the structured document 2 recursively. If a value is a nested object, the structure is traversed further. If a value is an array, the elements are iterated through. References are handled by showing their reference path.

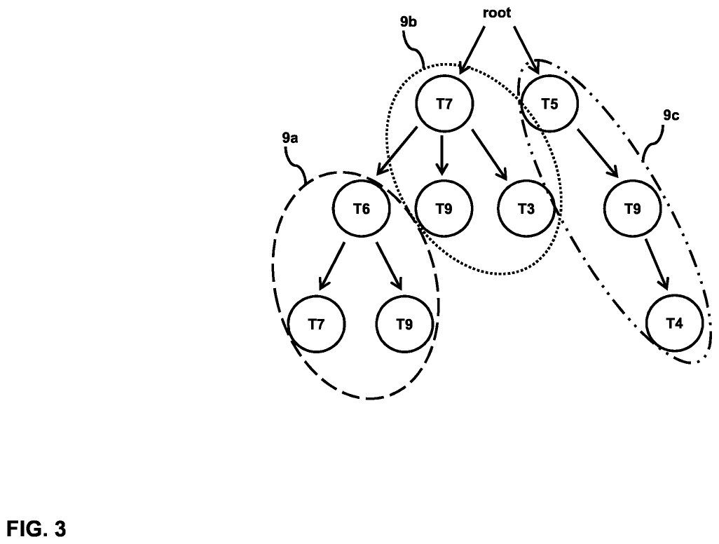

Subsequently, a defined token limit determines how tree nodes are grouped. A token is a unit of text that a natural language processing (NLP) model processes at one time. A token can represent a word, subunits or character, depending on the tokenization method used. Text is converted to tokens using a tokenizer, an algorithm or tool that converts raw text into tokens, with different models using various tokenization approaches. For instance, in transformer-based models like GPT from OpenAI, tokenization often splits words into smaller subunits to handle complex vocabulary efficiently. Three tree node groups are shown in FIG. 3, further identified by the differently dotted lines: 9a, 9b and 9c. The number in each node stands for the tokens this node comprises. Each group should not contain more tokens than the defined limit. In this simplified example, the defined limit is 22 tokens. In practice, the optimal limit may range from 600 to 800 tokens.

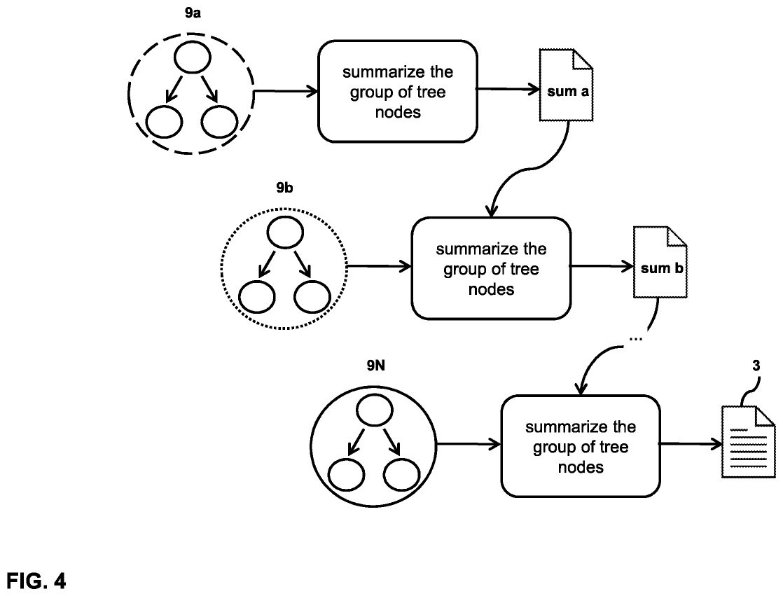

The method 1 generates the global summary 3 by performing chained summarization. FIG. 4 depicts this process. The method 1 generates a summary for each group of tree nodes, 9a, 9b up to 9N, with 9a representing the first group and 9N representing the last group. The summary of the previous group is part of the input of the summarization of the next group. In the given example, this means the summary for group 9b is created based on the tree nodes of group 9b and the previously created summary of group 9a. This process repeats until all groups are summarized. Thus, creating the global summary 3 of the structured document 2.

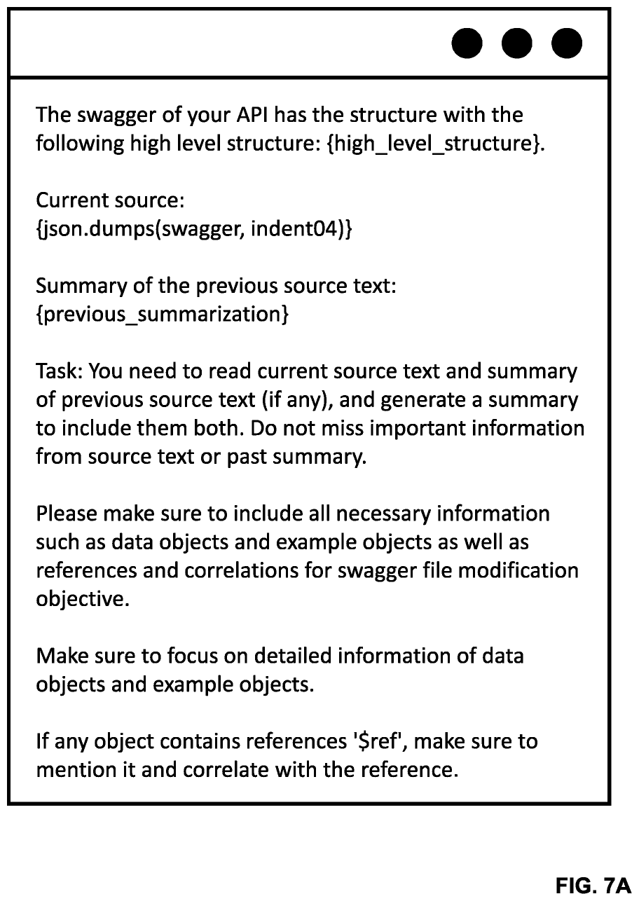

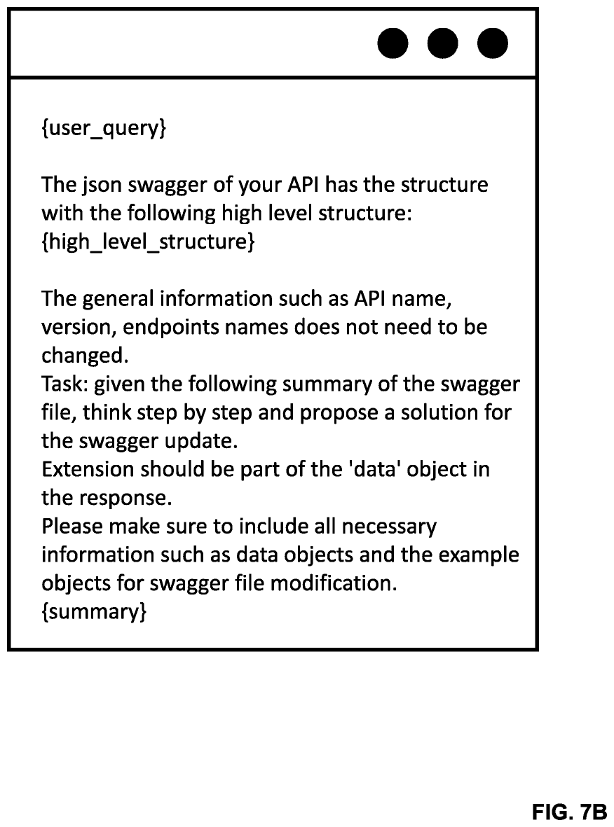

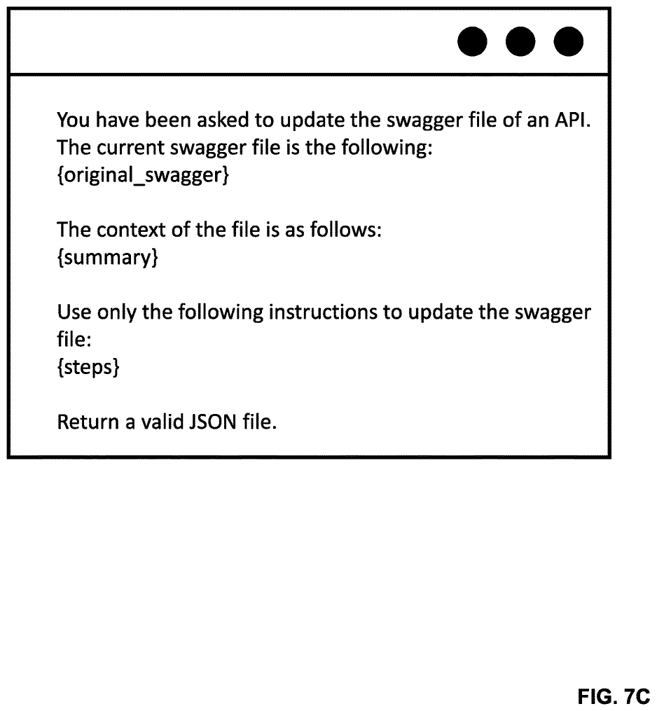

A possible prompt in case of executing this action with an LLM is shown in FIG. 7A. In this prompt the instructions are conveyed through full sentences. The curly brackets indicate variables—sections, which are later added in the prompt. The variable ‘{high_level_structure}’ will be replaced by the overall tree structure of the provided structured document 2. The function in the variable ‘{json.dumps(swagger, indent04)}’ provides the current group of tree nodes as JSON-formatted text. The variable ‘{previous_summarization}’ will be replaced by the summary of the previous group. Additionally, the LLM is reminded in the prompt to focus on data and example objects, as well as references.

This chained summarization process allows the whole context to remain consistent. Some relevant information may be contained within one group but needed in another group, as data such as placeholders, their values or templating information may be scattered across the entire tree structure. This way, information that is useful for the for the subsequent actions (e.g., placeholders, references) is preserved throughout the summarization process.

Actions 40 and 50 relate to first receiving a query 4 to modify the structured document 2, then refine and return the refined query 5. The method 1 includes receiving 40 a query 4 as input, as shown in FIG. 2, with directions on how to modify the structured document 2. The query 4 may be received by user input or a network transmission or by accessing the query 4 from memory (cf. FIG. 8 and description below). The query 4 may be concerned with changing the structured document 2, such as changing specific values or removing some details. For instance, the query 4 may ask to change the server URL from ‘“https://{environment}.example.com/api”’ to ‘“https://{environment}.qwerz.com/api”’. Further, the query 4 may request to extend the structured document. For example, in the case of a structured document 2 which describes an API, the query 4 may specify adding another endpoint (i.e., a specific URL or route through which clients can interact with a particular function or resource in the API) to the specification.

The query 4 may request multiple actions at once, such as combining the previous two examples: changing the server URL and extending the API with another endpoint. The query 4 is typically provided as text. This may be via a file—such as a plain text file, a markdown document or a structured format like JSON—or be entered directly by a user through an input field. The query 4 itself may take various forms, including full sentences, bullet points, keyword lists or structured prompts.

Next, the query 4 is refined 50 to express the sought modification more meaningfully, to ensure clarity, precision and effectiveness in communicating the directions. Vaguely or ambiguously described modifications can lead to misunderstandings or incomplete implementations. A well-articulated modification provides clear intent, context and rationale, facilitating accurately executing the required changes by any implementation tool.

For example, the vague query 4: “title prototype api” regarding the exemplary structured document 2 given in FIG. 1A, may be refined to the refined query 5: “Change the title of the API specification to Prototype API.” This adds a desired action—change—and the target object—the title of the API specification. The generated output is the refined query 5, shown in FIG. 2.

In some embodiments, the query 4 is refined on previously defined criteria. These criteria may concern different categories such as language, file format, structure and prompt engineering. Improving the language can mean refining the phrasing of the query 4. For example, the previously defined criteria may demand:
use shorter sentences
use imperative form
use clearer, less ambiguous words
avoid passive voice
remove redundant words
use consistent terminology

Improving the sought modification based on file format can mean refining or correcting any details specific to the file format of the structured document 1. For example, the previously defined criteria may address:
ensure well-formed syntax (e.g., closing tags in XML)
use proper encoding format
correct schema validation
correct use references
correct use templating rules

Improving the sought modification to address structural details can mean refining the query 4 based on the context of the structured document 2 to address the structural detail of the document. The context may be obtained based on the global summary 3. For example, the previously defined criteria may address:
correct hierarchy
consistent indentation
correct nesting of elements
alignment with predefined templates or schemas
   If refining the query 4 is based on the context of the structured document 2, the actions 20 and 30 may be required to be executed before action 50.

As the method 1 may be executed using LLMs, the query 4 may also be refined according to prompt engineering rules. For example, the previously defined criteria may address:
add an example of the modification
rephrase to chain-of-thought prompting
emphasize key details with formatting (e.g., bullet points)
use commands to instruct
rephrase negative directions to positive directions

Once the global summary 3 and the refined query 5 is obtained, an instruction 6 to modify the structured document 2 is generated 60 based on these two inputs. This data dependency is shown in FIG. 2 The instruction 6 contains the details to modify the structured document 2 as specified in the refined query 5. Thanks to the earlier refinement action, these details include not only the modification requested in the original query 4 but also the meaningful additions introduced during the refinement process 50. The instruction 6 may follow the same logical sequence as the structured document 2—mirroring the original structure. Alternatively, the instruction 6 may group the tasks that need to be performed by topic. In this case, the instructions are organized by subject matter, such as entity-based topics, functional topics or structural topics, clustering similar operations even if they appear in different parts of the document. The instructions 6 may also group the tasks around reusable parts, for example by module or component.

In case the method 1 is executed using an LLM, the prompt in FIG. 7B could be used to generate 60 the instruction 6. This exemplary prompt includes three variables: ‘{user_query}’—which will later be replaced by the actual user query, ‘{high_level_structure}’—the overall tree structure of the provided structured document 2 and ‘{summary}’—the global summary 3. The prompt includes a few general instructions to the model and uses the prompt engineering technique Chain of Thought (CoT) by asking the model to think step by step.

In some embodiments, the generated instruction 6 is a step-by-step instruction, a structured sequence of actions that outline in detail how the sought modification expressed in the refined query 5 is to be executed from start to finish. Each step is clear and follows a logical sequence to achieve the final modified document 7. According to the details contained in the global summary 3 and the specific notes highlighted in the refined query 5 the instruction 6 may consider details such as ensuring that a valid data format is kept or placeholder information is consistently kept throughout all the steps.

In some embodiments, the instruction 6 is generated based on grouped tree nodes. Then, the instruction 6 may group the tasks that need to be performed according to the grouped tree nodes, with each set of tasks corresponding to a distinct group. For example, the tasks in the instruction 6 are divided in the three tree node groups from FIG. 3: 9a, 9b and 9c. Generating the instruction 6 based on the grouped tree nodes helps preserve contextual integrity, particularly in large files with complex hierarchies and widely dispersed interrelated details. This approach ensures that modifications remain accurate and relevant within the broader document structure.

With these intermediate results generated, the structured document 2 is modified 70 based on the global summary 3 and the instruction 6 (shown in FIG. 2). The method 1 follows the outlined instructions 6 to implement the desired modification, ensuring that specific changes are correctly applied. Meanwhile, the global summary 3 provides a broader contextual overview of the structured document 2 to fill in missing details of the instruction 6. In certain cases, the instruction 6 alone may suffice for modifying the structured document 2, without requiring reference to the global summary 3. This is particularly true when the modification is localized, self-contained and does not impact other sections of the structured document 2. Likewise, this is the case when the instruction 6 itself is sufficiently clear and provides precise modification directives. While modification could be executed only based on the instruction 6, the global summary 3 ensures that modifications are not only accurate at the targeted location but also consistent with the overall document structure. By integrating both data sources, the modification process maintains document integrity while allowing precise, context-aware updates.

The modification process 70 may be executed in sequence, following the same logical order as the structured document 2. Sequential execution is typical when the modification 70 is performed on the single structured document 2. However, the modification process 70 may also be executed in parallel. This execution mode may be used when the entire structured document 6 is not modified at once, but instead, the individual chunks are modified. The chunking of the structured document 6 is explained in greater detail below. Synchronization mechanisms, such as generated instruction 6 which takes race conditions (two or more processes accessing shared resources) into account, ensure that shared resources, such as the grouped tree nodes are accessed safely.

A possible LLM prompt to execute the modification is shown in FIG. 7C. This prompt includes the structured document 2 through the variable ‘{original_swagger}’. The global summary 3 will replace the variable ‘{summary}’ and the last variable ‘{steps}’ includes the previously generated instruction 6. The prompt simply advises the LLM to execute the provided instructions in regard to the context of the structured document 2 and finally to return a valid JSON file.

The method 1 may face limits in processing the input or output context. This constraint can arise from multiple factors. First, the structured document 2 or the query 4 may be too complex, exceeding the system's ability to efficiently process large volumes of data. Classical algorithms like rule-based systems, while effective in specific scenarios, become impractical when dealing with extensive, structured and hierarchical data. The sheer number of cases and interdependencies that must be accounted for renders manual rule definition for every possible scenario infeasible. Even if the system can handle the structured document 2, processing the query 4, analyzing and modifying the structured document 2—potentially across multiple sections—can require very long processing times. This not only delays development initially but can lead to significant workflow disruptions if the query 4 overlooks a critical aspect, the method 1 fails, is interrupted or is aborted.

When the method 1 is implemented with LLMs, a different constraint arises: the model has a fixed input and output window that defines the amount of text the model can process at a time. Typically, the output window is smaller than the input window, forming the primary limiting factor. If the structured document 2 is too large to fit within the model's input window, the structured document 2 cannot be processed in its entirety. Similarly, if the required modifications generate an output exceeding the model's capacity, the response may be truncated or incomplete.

To address these processing limitations, some embodiments iteratively modify 70 the structured document 2 in smaller manageable chunks. The structured document 2 may be split based on a defined limit. This limit may be a fixed number of lines, characters or tokens or any other suitable measure. This ensures that each chunk remains within processing constraints while maintaining structural coherence.

In some embodiments, the structured document 2 may be split based on the previously created tree node groups (9a, 9b, 9c, . . . , 9N), allowing modifications to align with the structured document's 2 hierarchical structure. Each chunk is then processed individually by the method 1. Thus, changes are applied efficiently without overwhelming system resources. The method 1 may process these chunks sequentially, from top to bottom, modifying relevant sections as the method progresses. Alternatively, the method 1 first analyses the instruction 6 to determine which portions of the structured document 2 require modification. This targeted approach optimizes processing efficiency by focusing only on relevant chunks. Therefore, reducing computational overhead and minimizing unnecessary operations.

In some embodiments, the method 1 analyses the instruction 6 alongside the global summary 3 to split the structured document 2 based on the requested modifications and the contextual overview. Then, the created chunks are modified according to the instruction 6. To split the structured document 2 at the just identified appropriate points into the correct chunks, a suitable method must be chosen based on the structured document's 2 structure and content. This can be achieved through structural analysis, which helps recognize meaningful divisions. For example, pattern matching can detect recurring section titles, while parsing can analyze syntactic structures. Similarity search can group related content while separating distinct topics. By applying these techniques, the structured document 2 can be split into the required chunks while maintaining logical coherence.

For example, given the structured document 2 should be modified once at the very top and once at the very bottom, these two sections are split off from the structured document 2, creating 3 chunks—a small first chunk, a small last chunk and the middle chunk. The middle chunk remains unchanged, as no modifications are required. The first and the last chunk are further processed, modified or removed according to the instruction 6.

Further, given that the instruction 6 does not require modifying any existing part of the structured document 2 but outlines the addition of a new chunk, the structured document 2 may not need to be split into smaller chunks. Instead, the method 1 creates the new chunk based on the instruction 6 and the global summary 3.

Finally, the edited and any unedited chunks of the structured document 2 are combined into a final modified document 7. The reassembly may be the reversal of the previously performed process to split the structured document 2. In some embodiments, the instruction 6 outlines the required steps to combine the chunks into the modified document 7. All previously created chunks are collected, and their original order is determined. This may be done using for example metadata, numbering, timestamps or structural markers. Then, the chunks are merged while preserving formatting, paragraph breaks and other structural elements.

In some embodiments, the method 1 may perform a validation check to ensure file consistency and integrity. This validation process may involve multiple levels of verification, including syntax validation, schema validation and consistency checks. Syntax validation ensures that the modified document 7 adheres to the required formatting rules. For example, JSON parsers or linting tools can be used to detect syntax errors, misplaced brackets or improperly formatted elements. Schema validation verifies that the modified document 7 conforms to a predefined structural framework. This may involve checking against a JSO schema to enforce constraints such as data types, required fields, value ranges and hierarchical relationships. Additionally, type checking and constraint enforcement help prevent structural inconsistencies that could lead to processing errors. Beyond syntax and schema verification, the validation check may also ensure that document-specific details remain consistent between the structured document 2 and the modified document 7. This includes verifying the correct use of references, placeholders and any dependencies within the modified document 7.

Finally, the modified document 7 may be validated against the global summary 3 to confirm that the intended modifications align with the expected structure and content. This ensures that no critical information has been lost or misrepresented during the modification process. The final modified document 7 may be stored in memory or returned via a network or user interface (cf. FIG. 8 and description below).

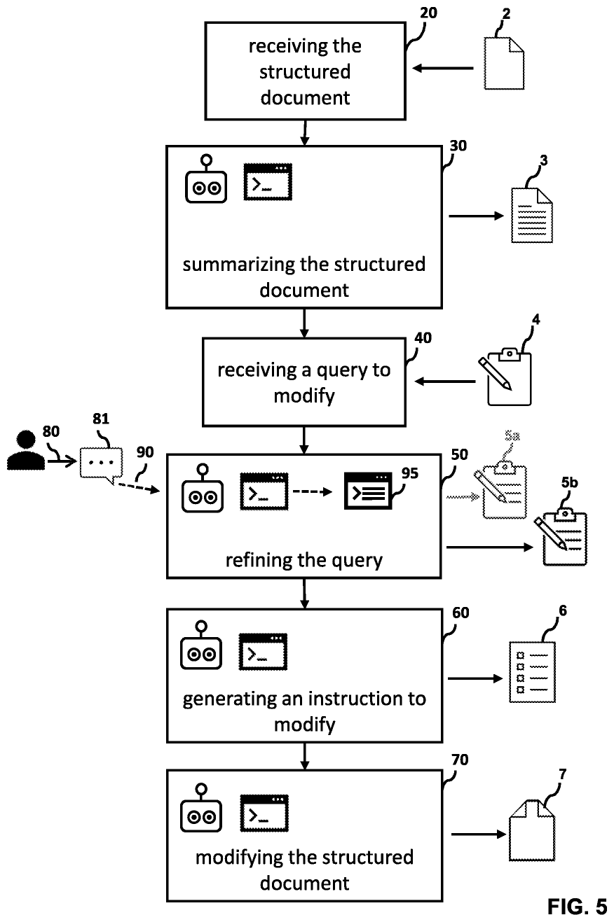

Optionally, a feedback loop to refine one or more large language model prompts may be implemented. An example of the feedback loop is depicted in FIG. 5. Once the method 1 has finished an action, the method 1 receives 80 a user generated feedback 81. Then, one or more LLM prompts are refined 90 according to the user generated feedback 81. The relevant action is repeated with the refined prompt, as well as all the subsequent actions. This feedback loop may repeat multiple times. Each time, the number of modified prompts may remain the same, increase or decrease.

An exemplary flow is depicted in FIG. 5. The method 1 receives 80 a user generated feedback 81 after the execution of refining 50 the query 4, where the intermediate output is the refined query 5a. The LLM prompt of this action 50 is refined 90 according to the user generated feedback 81. This results in the refined prompt 95. As there were no changes for the previous actions, the re-execution starts at action 50. The query 4 is refined 50 using the newly refined prompt 95 to generate a new refined query 5b. The subsequent actions are executed. As visualized in FIG. 2, the refined query 5 serves as input for generating 60 the instruction 6. Thus, the refined prompt 95 results in a new refined query 5b which in turn has an impact on the instruction 6, and so on.

In some embodiments, the user generated feedback 81 is given directly after the relevant action and the action is repeated. This scenario is illustrated in FIG. 5 and explained in greater detail above. The more immediate user generated feedback 81 offers the advantage of avoiding unnecessary actions and preventing the waste of computational resources. By integrating feedback early in the process, adjustments can be made dynamically, leading to a more efficient workflow.

However, the user generated feedback 81 may also be provided after the entire method 1 has finished and the modified document 7 has been generated. Delaying feedback until the end allows users to evaluate multiple actions at once, refining several prompts simultaneously. This holistic approach enables users to consider the overall outcome before adjusting, potentially leading to more substantial modifications. This said, LLM systems are highly sensitive to input. Modifying multiple prompts at once introduces a level of unpredictability in the output.

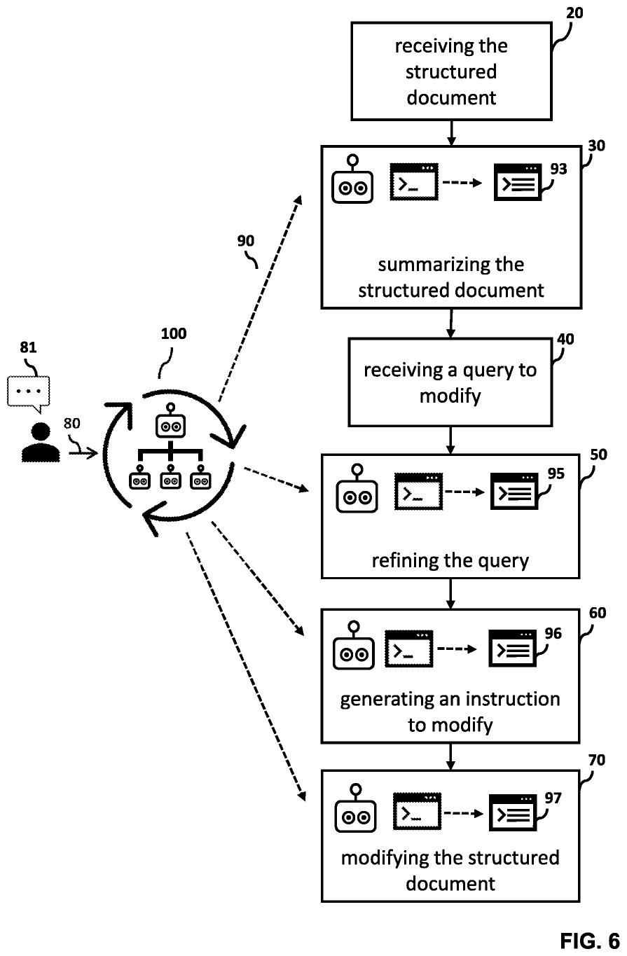

In some embodiments, the method 1 is carried out by an agentic system 100, in which autonomous agents collaborate to make decisions. An example of such a system is illustrated in FIG. 6. The agentic system 100 is capable of autonomous decision-making by independently reasoning and acting. Thus, minimizing the need for user intervention. The method 1 receives 80 a user generated feedback 81. Then, the agentic system 100 analyses the received feedback and decides autonomously which prompts need to be refined. Depending on the analysis, a single prompt or multiple prompts may be refined simultaneously. Once a selection is made, the agentic system proceeds to refine the one or more prompts. In the example shown in FIG. 6, the agentic system refines the prompt for summarizing 30 the structured document 2 into the refined prompt 93, the prompt of refining 50 the query 4 into refined prompt 95, the prompt of generating 60 an instruction 6 into refined prompt 96 and the last action of modifying 70 the structured document 2 into refined prompt 97. Then, the relevant actions are repeated using the refined prompts.

In an agentic system setup, the feedback loop may incorporate user generated feedback 81 before each prompt modification. In some embodiments, the agentic system 100 receives user generated feedback 81 once. After that, the agentic system 100 autonomously enters a cycle of execution and refinement until the agentic system 100 determines that the user's intended outcome has been achieved. This agentic approach typically requires greater processing resources and may be less deterministic. Due to the highly sensitive models executing each action, the agentic system may make intransparent decisions regarding which prompts to modify and how. Nonetheless, executing by an agentic system 100 requires less user intervention to achieve the desired result. Moreover, agentic systems are capable of autonomous learning. Even if their decision-making process is intransparent, their large-scale self-optimization mechanisms enable them to produce outcomes which might not be achievable through manual or systematic user modification.

Agentic systems can be implemented using various frameworks. For example, the Microsoft's AutoGen or its Semantic Kernel SDK offer tools for building such systems. LangChain, a framework designed to build language model-based applications, supports integrating agentic systems via the LangGraph extension. Another option is CrewAI, which facilitates the creation and management of collaborative multi-agent systems. These represent just a few examples of the many frameworks available, each offering diverse capabilities for developing agentic systems.

Each agent may be setup with a specific model different to other agents. This individual configuration allows choosing a model specialized in the assigned task. Typically, the OpenAI model GPT-4o provides good results as it is fast, capable and cost-effective. It may be used in an agentic setup as well as the single model in a reactive setup.

As mentioned above, the present methodologies may be provided by a computerized system, by an apparatus such as a computing machine CM-100 as well as by computer program instructions which, when executed by at least one processor, realizes the operations described above.

FIG. 8 is a diagrammatic representation of the internal components of a computing machine CM-100 implementing the functionality of the method 1. The computing machine CM-100 includes a set of instructions to cause the computing machine CM-100 to perform any of the methodologies discussed herein when executed. The computing machine CM-100 includes at least one processor CM-101, a network interface device CM-102, a user interface device CM-103 and a main memory CM-106, which communicate with each other via a bus CM-104. Optionally, the computing machine CM-101 may further include a static memory CM-105 and a disk-drive unit. A video display, an alpha-numeric input device and a cursor control device may be provided as examples of user interface CM-103. The network interface device CM-102 may connect the computing machine CM-100 to the other components of a distributed processing system.

The main memory CM-106 may store temporary program data to facilitate the functionality of the computing machine CM-100. For example, the main memory CM-106 may store computer program data CM-108 to implement functionalities to summarize 30 of the structured document 2, as described above. The main memory CM-106 may also receive and store a file or a database for further processing. For example, the main memory CM-106 may receive and store a structured document 2, for instance from the user interface device CM-103 or the network interface device CM-102. The same may also be held in the static memory CM-105. Either the main memory CM-106 or the static memory CM-105 may be accessed to receive files or other data for further processing, such as the structured document 2 or intermediate processing results like the summarization of the group of tree nodes (9a, 9b, . . . , 9N).

A set of computer-executable instructions (computer program code CM-108) embodying any one, or all, of the methodologies described herein, resides completely, or at least partially, in or on a machine-readable storage medium, e.g., the main memory CM-106. For example, the instructions CM-108 may include software processes implementing the summarization 30 of the structured document 2. The instructions CM-108 may also implement the further processing functionalities, such as receiving 40 a query 4, refining 50 the query 4, generating 60 an instruction 6, modifying 70 the structured document 2. Further, the instructions CM-108 may implement storing the final modified document 7 in the main memory CM-106 or the static memory CM-105 and may also return the final modified document 7 via the network interface device CM-102 or the user interface CM-103.

The instructions CM-108 may further be transmitted or received as a propagated signal via the Internet through the network interface device CM-102 or via the user interface CM-103. Communication with the computing machine CM-100 is performed via the bus CM-104. Basic operation of the CM-100 is controlled by an operating system which is also located in the main memory CM-106, the at least one processor CM-101 and/or the static memory CM-105.

In general, the routines executed to implement the embodiments, whether implemented as part of an operating system or a specific application, component, program, object, module or sequence of instructions, or even a subset thereof, may be referred to herein as “computer program code” or simply “program code”. Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the disclosure. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While a description of various embodiments has illustrated all of the inventions and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the applicant's general inventive concept.

The invention can be summarized by way of the following aspects:
1. A computer implemented method for modifying a structured document comprising:
   receiving the structured document, wherein the structured document comprises multiple items;
   summarizing the structured document based on grouping the items to obtain a global summary of the structured document;
   receiving a query to modify the structured document;
   refining the query to specify the sought modification of the structured document more meaningfully;
   generating an instruction to modify the structured document based on the refined query and the global summary;
   modifying the structured document based on the instruction and the global summary.
2. The method of aspect 1, wherein summarizing the structured document comprises:
   building a tree structure consisting of tree nodes;
   group the tree nodes based on a defined token limit;
   generate a summary for each group of tree nodes where the previously generated summary is incorporated into the summarization process for the next group;
   creating the global summary of the whole structured document based on the summary of each group.
3. The method of aspect 1 or 2, wherein the generated instruction to modify the structured document is a step-by-step instruction.
4. The method of aspect 2, wherein the generated instruction to modify the structured document is a step-by-step instruction based on the grouped tree nodes.
5. The method of aspect 4, wherein the structured document is iteratively modified based on the step-by-step instruction, the global summary and the grouped tree nodes.
6. The method of one of the aspect 1 to 5, wherein the query to modify the structured document comprises changing or extending the structured document.
7. The method of aspect 6, wherein refining the query is based on previously defined criteria.
8. The method of aspect 7, wherein refining the query is further based on the context of the structured document.
9. The method of aspect 1 to 8, wherein generating the instruction is further based on an extracted top-level schema of the structured document.
10. The method of one of the aspect 1 to 9, wherein one or more processing steps are executed by large language models.
11. The method of aspect 10, further comprising:
   receiving a user generated feedback;
   refining one or more large language model prompts according to the feedback;
   executing the sequence of processing steps using the one or more refined prompt.
12. A computerized system being arranged to perform the method of any one of aspects 1 to 11.
13. A computer program with program instructions which, when executed by at least one processor, implements the method of any one of aspects 1 to 11.

1. A computerized system for modifying a structured document, the system configured to:
receive the structured document, wherein the structured document comprises multiple items;
summarize the structured document based on grouping the items to obtain a global summary of the structured document;
receive a query to modify the structured document;
refine the query to specify the sought modification of the structured document more meaningfully;
generate an instruction to modify the structured document based on the refined query and the global summary; and
modify the structured document based on the instruction and the global summary.

2. The computerized system of claim 1, wherein summarizing the structured document comprises:
building a tree structure consisting of tree nodes;
group the tree nodes based on a defined token limit;
generate a summary for each group of tree nodes where the previously generated summary is incorporated into the summarization process for the next group; and
creating the global summary of the whole structured document based on the summary of each group.

3. The computerized system of claim 1, wherein the generated instruction to modify the structured document is a step-by-step instruction.

4. The computerized system of claim 2, wherein the generated instruction to modify the structured document is a step-by-step instruction based on the grouped tree nodes.

5. The computerized system of claim 4, wherein the structured document is iteratively modified based on the step-by-step instruction, the global summary and the grouped tree nodes.

6. The computerized system of claim 1, wherein the query to modify the structured document comprises changing or extending the structured document.

7. The computerized system of claim 6, wherein refining the query is based on previously defined criteria.

8. The computerized system of claim 7, wherein refining the query is further based on the context of the structured document.

9. The computerized system of claim 1, wherein generating the instruction is further based on an extracted top-level schema of the structured document.

10. The computerized system of claim 1, wherein one or more processing steps are executed by large language models.

11. The computerized system of claim 10, the system further configured to:
receive a user generated feedback;
refine one or more large language model prompts according to the feedback; and
execute the sequence of processing steps using the one or more refined prompt.

12. A non-transitory computer readable medium storing program instructions which, when executed by at least one processor, implements a set of operations comprising:
receiving the structured document, wherein the structured document comprises multiple items;
summarizing the structured document based on grouping the items to obtain a global summary of the structured document;
receiving a query to modify the structured document;
refining the query to specify the sought modification of the structured document more meaningfully;
generating an instruction to modify the structured document based on the refined query and the global summary; and
modifying the structured document based on the instruction and the global summary.

13. A computer implemented method for modifying a structured document comprising:
receiving the structured document, wherein the structured document comprises multiple items;
summarizing the structured document based on grouping the items to obtain a global summary of the structured document;
receiving a query to modify the structured document;
refining the query to specify the sought modification of the structured document more meaningfully;
generating an instruction to modify the structured document based on the refined query and the global summary; and
modifying the structured document based on the instruction and the global summary.

14. The method of claim 13, wherein summarizing the structured document comprises:
building a tree structure consisting of tree nodes;
group the tree nodes based on a defined token limit;
generate a summary for each group of tree nodes where the previously generated summary is incorporated into the summarization process for the next group; and
creating the global summary of the whole structured document based on the summary of each group.

15. The method of claim 13, wherein the generated instruction to modify the structured document is one or more of a step-by-step instruction and a step-by-step instruction based on the grouped tree nodes.

16. The method of claim 15, wherein the structured document is iteratively modified based on the step-by-step instruction, the global summary and the grouped tree nodes.

17. The method of claim 13, wherein the query to modify the structured document comprises changing or extending the structured document.

18. The method of claim 17, wherein refining the query is based on one or more of previously defined criteria and the context of the structured document.

19. The method of claim 13, wherein generating the instruction is further based on an extracted top-level schema of the structured document.

20. The method of claim 13, wherein one or more processing steps are executed by large language models, and the method further comprises:
receiving a user generated feedback;
refining one or more large language model prompts according to the feedback; and
executing the sequence of processing steps using the one or more refined prompt.
